(19) United States
(12) Patent Application Publication
(10) Pub. No.: US 2018/0182320 A1
(43) Pub. Date: Jun. 28, 2018

(54) HALF SOURCE DRIVING LIQUID CRYSTAL DISPLAY PANEL AND LIQUID CRYSTAL DISPLAY

(71) Applicant: SHENZHEN CHINA STAR OPTOELECTRONICS TECHNOLOGY CO., LTD., Shenzhen (CN)

(72) Inventor: Jiang ZHU, Shenzhen (CN)

(73) Assignee: SHENZHEN CHINA STAR OPTOELECTRONICS TECHNOLOGY CO., LTD., Shenzhen (CN)

(21) Appl. No.: 15/311,858

(22) PCT Filed: Jul. 12, 2016
(86) PCT No.: PCT/CN2016/089719

§ 371 Date: Nov. 17, 2016

(30) Foreign Application Priority Data
Jun. 22, 2016 (CN) 201610459699.7

(51) Int. Cl. G09G 3/36

(52) U.S. Cl. CPC G09G 3/3607; G09G 3/3622; G09G 2310/027; G09G 2320/0626; G09G 2300/0426; G09G 2320/0233

(57) ABSTRACT

The present disclosure proposes a HSD liquid crystal display panel. The HSD liquid crystal display panel includes a data line, a scan line, and pixel units. Each of the pixel units comprises a first subpixel unit and a second subpixel unit. Each of the first subpixel units on each column and the corresponding second subpixel unit are both connected to the same data line. The first subpixel units on add rows are connected to the first sub-scan line, and the second subpixel units on add rows are connected to the second sub-scan line. The first subpixel units on even-numbered rows are connected to the second sub-scan line, and the second subpixel units on even-numbered rows are connected to the first sub-scan line.

### BACKGROUND OF THE INVENTION

### 1. Field of the Invention

The present invention is related to the field of liquid crystal display, and more particularly, to a half source driving (HSD) liquid crystal display panel and a liquid crystal display (LCD).

### 2. Description of the Prior Art

In the conventional technology, two neighboring subpixels in a column direction on an HSD pixel array shares the same data line. So the number of the data line used by the conventional HSD pixel array is half the number of the conventional liquid crystal driving pixel array. The neighboring subpixels on the same row are connected to different scan lines, and every other one subpixels on the same row are connected to the same scan line. The two neighboring subpixels in a row direction are connected to different scan lines. So a data line is arranged between subpixels on every two columns to enhance the aperture rate of a liquid crystal display panel.

The conventional technology adopts the liquid crystal pixel having a multi-domain structure. That is, the pixel units are segmented into smaller display units, and the driving voltage imposed on two subpixel units of each display unit is proportional. So the angle of deflection of liquid crystal molecules in each display unit is different, which improves color shift of the LCD.

However, the liquid crystal display panel having the multi-domain structure has the drawback of low transmittance. It is necessary to enhance the working power of the backlight source to make the brightness of the LCD meet a certain degree, which causes an increase in power consumption and production costs of the LCD.

Therefore, an object of the present invention is to propose an HSD liquid crystal display panel and an LCD to solve the problem existing in the conventional technology.

### SUMMARY OF THE INVENTION

An object of the present invention is to propose an HSD liquid crystal display panel and an LCD which features smaller power consumption, smaller production costs, and better display quality in order to solve the problems that the conventional HSD liquid crystal display panel and the LCD consume more power, cost higher, and display poorer images.

The present disclosure proposes a half source driving (HSD) liquid crystal display panel. The HSD liquid crystal display panel includes a data line, a scan line, pixel units arranged between the data line and the scan line. Each of the pixel units comprises a first subpixel unit and a second subpixel unit. The scan line comprises a first sub-scan line for supplying a first scan signal and a second sub-scan line for supplying a second scan signal. Each of the first subpixel units on each column and the corresponding second subpixel unit are both connected to the same data line. The first subpixel units on add rows are connected to the first sub-scan line, and the second subpixel units on add rows are connected to the second sub-scan line. The first subpixel units on even-numbered rows are connected to the second sub-scan line, and the second subpixel units on even-numbered rows are connected to the first sub-scan line. The polarities of the data signals of the neighboring data lines are opposite.

In the HSD liquid crystal display panel of the present disclosure, in one frame of an image, the polarity of the data signal through all of the data lines when the (4n+1)th first sub-scan line stays high voltage level is the same as the polarity of the data signal through all of the data lines when the (4n+2)th first sub-scan line stays high voltage level. The polarity of the data signal through all of the data lines when the (4n+3)th first sub-scan line stays high voltage level is the same as the polarity of the data signal through all of the data lines when the (4n+4)th first sub-scan line stays high voltage level. The polarity of the data signal through all of the data lines when the (4n+1)th first sub-scan line stays high voltage level contradicts the polarity of the data signal through all of the data lines when the (4n+3)th first sub-scan line stays high voltage level.

In the HSD liquid crystal display panel of the present disclosure, in one frame of an image, the polarity of the data signal through all of the data lines when the (4n+1)th second sub-scan line stays high voltage level is the same as the polarity of the data signal through all of the data lines when the (4n+2)th second sub-scan line stays high voltage level. The polarity of the data signal through all of the data lines when the (4n+3)th second sub-scan line stays high voltage level is the same as the polarity of the data signal through all of the data lines when the (4n+4)th second sub-scan line stays high voltage level. The polarity of the data signal through all of the data lines when the (4n+1)th second sub-scan line stays high voltage level contradicts the polarity of the data signal through all of the data lines when the (4n+3)th second sub-scan line stays high voltage level.

In the HSD liquid crystal display panel of the present disclosure, in one frame of an image, the polarity of the data signal through all of the data lines when the first sub-scan line stays high voltage level is the same as the polarity of the data signal through all of the data lines when the corresponding second sub-scan line stays high voltage level.

The present disclosure also proposes a half source driving (HSD) liquid crystal display panel. The HSD liquid crystal display panel includes a data line, a scan line, pixel units arranged between the data line and the scan line. Each of the pixel units comprises a first subpixel unit and a second subpixel unit. The scan line comprises a first sub-scan line for supplying a first scan signal and a second sub-scan line for supplying a second scan signal. Each of the first subpixel units on each column and the corresponding second subpixel unit are both connected to the same data line. The first subpixel units on add rows are connected to the first sub-scan line, and the second subpixel units on add rows are connected to the second sub-scan line. The first subpixel units on even-numbered rows are connected to the second sub-scan line, and the second subpixel units on even-numbered rows are connected to the first sub-scan line.

In the HSD liquid crystal display panel of the present disclosure, the polarities of the data signals of the neighboring data lines are opposite.

In the HSD liquid crystal display panel of the present disclosure, in one frame of an image, the polarity of the data signal through all of the data lines when the (4n+1)th first sub-scan line stays high voltage level is the same as the polarity of the data signal through all of the data lines when the (4n+2)th first sub-scan line stays high voltage level. The polarity of the data signal through all of the data lines when the (4n+3)th first sub-scan line stays high voltage level is the same as the polarity of the data signal through all of the data lines when the (4n+4)th first sub-scan line stays high voltage level. The polarity of the data signal through all of the data lines when the (4n+1)th first sub-scan line stays high voltage level contradicts the polarity of the data signal through all of the data lines when the (4n+3)th first sub-scan line stays high voltage level.

In the HSD liquid crystal display panel of the present disclosure, in one frame of an image, the polarity of the data signal through all of the data lines when the (4n+1)th second sub-scan line stays high voltage level is the same as the polarity of the data signal through all of the data lines when the (4n+2)th second sub-scan line stays high voltage level. The polarity of the data signal through all of the data lines when the (4n+3)th second sub-scan line stays high voltage level is the same as the polarity of the data signal through all of the data lines when the (4n+4)th second sub-scan line stays high voltage level. The polarity of the data signal through all of the data lines when the (4n+1)th second sub-scan line stays high voltage level contradicts the polarity of the data signal through all of the data lines when the (4n+3)th second sub-scan line stays high voltage level.

In the HSD liquid crystal display panel of the present disclosure, in one frame of an image, the polarity of the data signal through all of the data lines when the first sub-scan line stays high voltage level is the same as the polarity of the data signal through all of the data lines when the corresponding second sub-scan line stays high voltage level.

In the HSD liquid crystal display panel of the present disclosure, the first subpixel unit displays a data signal with high brightness, and the corresponding second subpixel unit displays a data signal with low brightness in the meantime.

In the HSD liquid crystal display panel of the present disclosure, the first subpixel unit displays a data signal with low brightness, and the corresponding first subpixel unit displays a data signal with high brightness in the meantime.

The present disclosure further proposes a liquid crystal display comprising a backlight source and a half source driving (HSD) liquid crystal display panel which includes a data line, a scan line, pixel units arranged between the data line and the scan line. Each of the pixel units comprises a first subpixel unit and a second subpixel unit. The scan line comprises a first sub-scan line for supplying a first scan signal and a second sub-scan line for supplying a second scan signal. Each of the first subpixel units on each column and the corresponding second subpixel unit are both connected to the same data line. The first subpixel units on add rows are connected to the first sub-scan line, and the second subpixel units on add rows are connected to the second sub-scan line. The first subpixel units on even-numbered rows are connected to the second sub-scan line, and the second subpixel units on even-numbered rows are connected to the first sub-scan line.

In the HSD liquid crystal display panel of the present disclosure, the polarities of the data signals of the neighboring data lines are opposite.

In the liquid crystal display of the present disclosure, in one frame of an image, the polarity of the data signal through all of the data lines when the (4n+1)th first sub-scan line stays high voltage level is the same as the polarity of the data signal through all of the data lines when the (4n+2)th first sub-scan line stays high voltage level. The polarity of the data signal through all of the data lines when the (4n+3)th first sub-scan line stays high voltage level is the same as the polarity of the data signal through all of the data lines when the (4n+4)th first sub-scan line stays high voltage level. The polarity of the data signal through all of the data lines when the (4n+1)th first sub-scan line stays high voltage level contradicts the polarity of the data signal through all of the data lines when the (4n+3)th first sub-scan line stays high voltage level.

In the liquid crystal display of the present disclosure, in one frame of an image, the polarity of the data signal through all of the data lines when the (4n+1)th second sub-scan line stays high voltage level is the same as the polarity of the data signal through all of the data lines when the (4n+2)th second sub-scan line stays high voltage level. The polarity of the data signal through all of the data lines when the (4n+3)th second sub-scan line stays high voltage level is the same as the polarity of the data signal through all of the data lines when the (4n+4)th second sub-scan line stays high voltage level. The polarity of the data signal through all of the data lines when the (4n+1)th second sub-scan line stays high voltage level contradicts the polarity of the data signal through all of the data lines when the (4n+3)th second sub-scan line stays high voltage level.

In the liquid crystal display of the present disclosure, in one frame of an image, the polarity of the data signal through all of the data lines when the first sub-scan line stays high voltage level is the same as the polarity of the data signal through all of the data lines when the corresponding second sub-scan line stays high voltage level.

In the liquid crystal display of the present disclosure, the first subpixel unit displays a data signal with high brightness, and the corresponding second subpixel unit displays a data signal with low brightness in the meantime.

In the liquid crystal display of the present disclosure, the first subpixel unit displays a data signal with low brightness, and the corresponding first subpixel unit displays a data signal with high brightness in the meantime.

Compared with the conventional HSD liquid crystal display panel and the LCD, the present invention proposes an HSD liquid crystal display panel and an LCD adopting the method of connecting different pixel units on different rows to different scan lines to realize multi-domain display of the liquid crystal display panel. It is not necessary to establish a multi-domain structure on the liquid crystal display panel. So power consumption of the liquid crystal display panel and production costs of the liquid crystal display panel do not increase; instead, the display quality of the liquid crystal display panel improves. The present invention can successfully solve the problem that the conventional HSD liquid crystal display panel and the LCD consume more power, cost higher, and display poorer images.

### BRIEF DESCRIPTION OF THE DRAWINGS

For better understanding embodiments of the present invention, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

FIG. 1 shows a schematic diagram of the structure of a half source driving (HSD) liquid crystal display panel according to a first preferred embodiment of the present invention.

FIG. 2 shows a schematic diagram of the structure of a half source driving (HSD) liquid crystal display panel according to a second preferred embodiment of the present invention.

### DETAILED DESCRIPTION OF THE PREFERRED EMBODIMENTS

These and other objectives of the claimed invention will no doubt become obvious to those of ordinary skill in the art after reading the following detailed description of the preferred embodiment that is illustrated in the various figures and drawings.

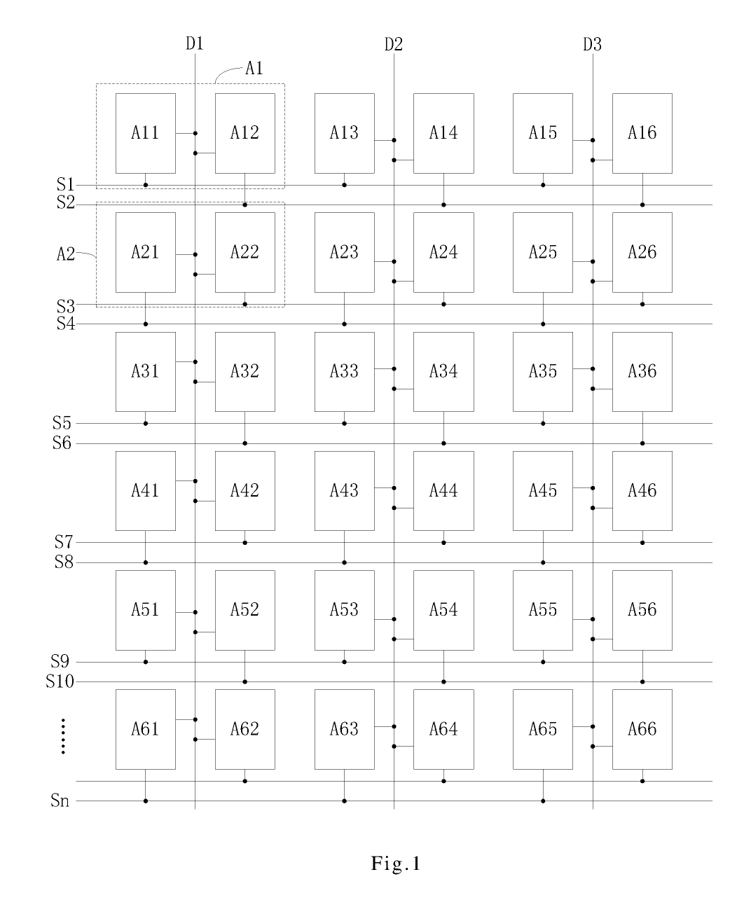

Please refer to FIG. 1 showing a schematic diagram of the structure of a half source driving (HSD) liquid crystal display panel according to a first preferred embodiment of the present invention. The HSD liquid crystal display panel comprises a data line, a scan line, a pixel unit arranged between the data line and the scan line.

Each pixel unit comprises a first subpixel unit and a second subpixel unit. The scan line comprises a first sub-scan line for a first scan signal and a second sub-scan line for a second scan signal. Each of the first subpixel units on each column and its corresponding second subpixel unit are both connected to the same data line. The first subpixel units on the add rows are connected to the first sub-scan line, and the second subpixel units on the add rows are connected to the second sub-scan line. The first subpixel units on the even-numbered rows are connected to the second sub-scan line, and the second subpixel units on the even-numbered rows are connected to the first sub-scan line. The polarity of the data signal through a data line is opposite to that of the data signal through a neighboring data line.

The first subpixel unit shows the data signal with high brightness, and a corresponding second subpixel unit displays a data signal with low brightness in this embodiment.

Please refer to FIG. 1. The pixel unit A1 comprises a first subpixel unit A11 and a second subpixel unit A12. The pixel unit A2 comprises a first subpixel unit A21 and a second subpixel unit A22. The first subpixel unit A11, the second subpixel unit A12, the first subpixel unit A21, and the second subpixel unit A22 are connected to the D1, respectively. The first subpixel unit A11 on the odd-numbered row is connected to the first sub-scan line S1, and the second subpixel unit A12 on the odd-numbered row is connected to the second sub-scan line S2. The first subpixel unit A21 on the even-numbered row is connected to the second sub-scan line S4, and the second subpixel unit A22 on the even-numbered row is connected to the first sub-scan line S3.

If the polarity of the data signal through the data line D1 is positive, the polarity of the data signal through the data line D2 is negative. If the polarity of the data signal through the data line D1 is negative, the polarity of the data signal through the data line D2 is positive.

In one frame of an image, the scan line scans in turn. That is, the first sub-scan line and its corresponding second sub-scan line scan in turn. For example, the scan signal through the first sub-scan line S1 transits from high voltage level to low voltage level. Then, the scan signal through the second sub-scan line S2 transits from high voltage level to low voltage level. Then, the scan signal through the first sub-scan line S3 transits from high voltage level to low voltage level. Finally, the scan signal through the second sub-scan line Sn transits from high voltage level to low voltage level.

The polarity of the data signal of the pixel units on every four rows is taken as a circle unit. For example, when the (4n+1)th first sub-scan line stays high voltage level, the polarity of the data signal of the first pixel unit on the (4n+1)th row is positive, negative, . . . , positive, and negative. When the (4n+2)th first sub-scan line stays high voltage level, the polarity of the data signal of the first pixel unit on the (4n+2)th row is positive, negative, . . . , positive, and negative. When the (4n+3)th first sub-scan line stays high voltage level, the polarity of the data signal of the first pixel unit on the (4n+3)th row is negative, positive, . . . , negative, and positive. When the (4n+4)th first sub-scan line stays high voltage level, the polarity of the data signal of the first pixel unit on the (4n+4)th row is negative, positive, . . . , negative, and positive.

When the (4n+1)th second sub-scan line stays high voltage level, the polarity of the data signal of the second pixel unit on the (4n+1)th row is positive, negative, . . . , positive, and negative. When the (4n+2)th second sub-scan line stays high voltage level, the polarity of the data signal of the second pixel unit on the (4n+2)th row is positive, negative, . . . , positive, and negative. When the (4n+3)th second sub-scan line stays high voltage level, the polarity of the data signal of the second pixel unit on the (4n+3)th row is negative, positive, . . . , negative, and positive. When the (4n+4)th second sub-scan line stays high voltage level, the polarity of the data signal of the second pixel unit on the (4n+4)th row is negative, positive, . . . , negative, and positive.

The first sub-scan line S1 transits from low voltage level to high voltage level when the HSD liquid crystal display panel shows one single frame of an image. The first subpixel unit A11 receives and shows the data signal with high brightness and positive polarity through the data line D1 at this time. Next, the second sub-scan line S2 transits from low voltage level to high voltage level, and the second subpixel unit A12 receives and shows the data signal with low brightness and positive polarity through the data line D1 at this time. Next, the first sub-scan line S3 transits from low voltage level to high voltage level, and the first subpixel unit A22 receives and shows the data signal with high brightness and positive polarity through the data line D1 at this time. Afterwards, the second sub-scan line S4 transits from low voltage level to high voltage level, and the second subpixel unit A21 receives and shows the data signal with low brightness and positive polarity through the data line D1 at this time.

The first scan line S5 transits from low voltage level to high voltage level, and the first subpixel unit A31 receives and shows the data signal with high brightness and negative polarity through the data line D1 at this time. Next, the second scan line S6 transits from low voltage level to high voltage level, and the second subpixel unit A32 receives and shows the data signal with low brightness and negative polarity through the data line D1 at this time. Next, the first scan line S7 transits from low voltage level to high voltage level, and the first subpixel unit A42 receives and shows the data signal with high brightness and negative polarity through the data line D1 at this time. Afterwards, the second scan line S8 transits from low voltage level to high voltage level, and the second subpixel unit A41 receives and shows the data signal with low brightness and negative polarity through the data line D1 at this time.

At the same time, the polarity of the data signal through the data line D2 adjacent to the data line D1 contradicts the polarity of the data signal through the data line D1.

The first sub-scan line S1 transits from low voltage level to high voltage level. The first subpixel unit A13 receives and shows the data signal with high brightness and negative polarity through the data line D2 at this time. Next, the second sub-scan line S2 transits from low voltage level to high voltage level, and the second subpixel unit A14 receives and shows the data signal with low brightness and negative polarity through the data line D2 at this time. Next, the first sub-scan line S3 transits from low voltage level to high voltage level, and the first subpixel unit A24 receives and shows the data signal with high brightness and negative polarity through the data line D2 at this time. Afterwards, the second sub-scan line S4 transits from low voltage level to high voltage level, and the second subpixel unit A23 receives and shows the data signal with low brightness and negative polarity through the data line D2 at this time.

The first scan line S5 transits from low voltage level to high voltage level, and the first subpixel unit A33 receives and shows the data signal with high brightness and positive polarity through the data line D2 at this time. Next, the second scan line S6 transits from low voltage level to high voltage level, and the second subpixel unit A34 receives and shows the data signal with low brightness and positive polarity through the data line D2 at this time. Next, the first scan line S7 transits from low voltage level to high voltage level, and the first subpixel unit A44 receives and shows the data signal with high brightness and positive polarity through the data line D2 at this time. Afterwards, the second scan line S8 transits from low voltage level to high voltage level, and the second subpixel unit A43 receives and shows the data signal with low brightness and positive polarity through the data line D2 at this time.

So a single frame of the image is shown on the HSD liquid crystal display panel, whether on a displaying row or a displaying column, the subpixel unit showing the data signal with high brightness and the subpixel unit showing the data signal with low brightness all are arranged alternatively. So the subpixel units have a better balanced charging effect.

Meanwhile, the polarity of the data signal reverses for the subpixel units on every two rows or on every two columns. Therefore, the subpixel units are more fully charged. The quality of the images shown on the panel is much better as well.

The connection of different scan lines for the pixel units on different rows are used in the HSD liquid crystal display panel proposed by the preferred embodiment of the present invention. So the liquid crystal display panel can display in a multi-domain instead of arranging a multi-domain structure on the liquid crystal display panel. As can been seen, the display quality of the liquid crystal display panel is still enhanced without increasing power consumption and production costs of the liquid crystal display panel.

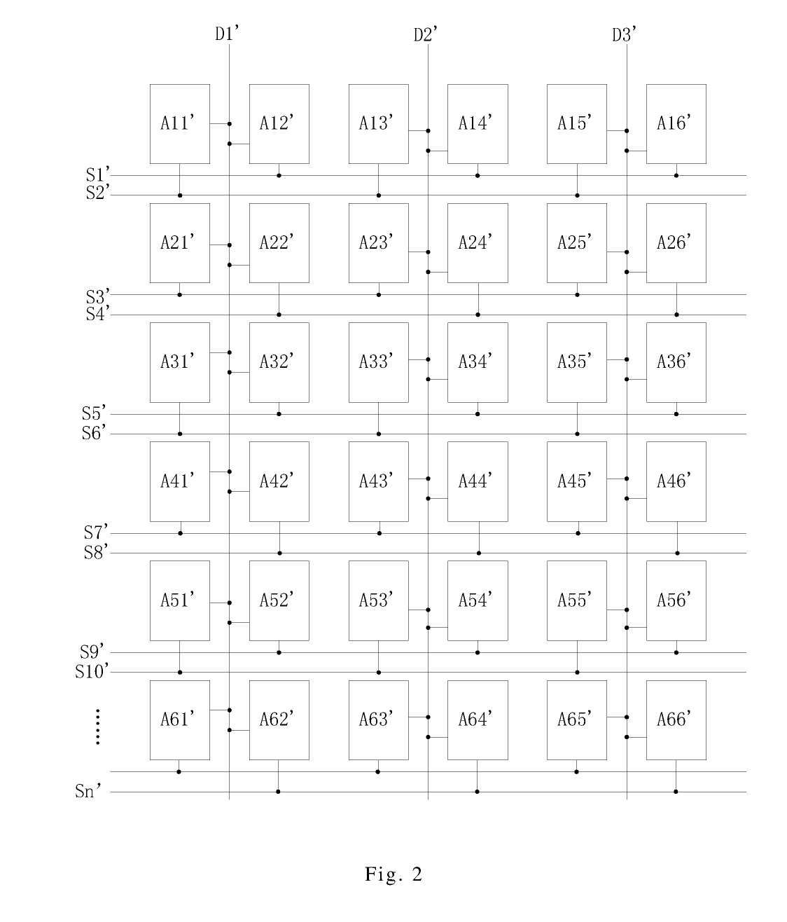

Please refer to FIG. 2 showing a schematic diagram of the structure of a half source driving (HSD) liquid crystal display panel according to a second preferred embodiment of the present invention. The HSD liquid crystal display panel comprises a data line, a scan line, a pixel unit arranged between the data line and the scan line.

Based on the first preferred embodiment, a first subpixel unit displays a data signal with low brightness, and a corresponding second subpixel unit displays a data signal with high brightness in this embodiment.

A first sub-scan line S1′ transits from low voltage level to high voltage level when the HSD liquid crystal display panel shows one single frame of an image. A first subpixel unit A12′ receives and shows the data signal with low brightness and positive polarity through a data line D1′ at this time. Next, a second sub-scan line S2′ transits from low voltage level to high voltage level, and the second subpixel unit A11′ receives and shows the data signal with high brightness and positive polarity through the data line D1′ at this time. Next, a first sub-scan line S3 transits from low voltage level to high voltage level, and a first subpixel unit A21′ receives and shows the data signal with low brightness and positive polarity through the data line D1′ at this time. Afterwards, the second scan line D1′ transits from low voltage level to high voltage level, and a second subpixel unit A22′ receives and shows the data signal with high brightness and positive polarity through the data line D1′ at this time.

The first scan line S5′ transits from low voltage level to high voltage level, and the first subpixel unit A32′ receives and shows the data signal with low brightness and negative polarity through the data line D1′ at this time. Next, the second scan line S6′ transits from low voltage level to high voltage level, and the second subpixel unit A31′ receives and shows the data signal with high brightness and negative polarity through the data line D1′ at this time. Next, the first scan line S7′ transits from low voltage level to high voltage level, and the first subpixel unit A41′ receives and shows the data signal with low brightness and negative polarity through the data line D1′ at this time. Afterwards, the second scan line S8′ transits from low voltage level to high voltage level, and the first subpixel unit A42′ receives and shows the data signal with high brightness and negative polarity through the data line D1 at this time.

At the same time, the polarity of the data signal through the data line D2′ adjacent to the data line D1′ contradicts the polarity of the data signal through the data line D1′.

The first sub-scan line S1′ transits from low voltage level to high voltage level. The first subpixel unit A14′ receives and shows the data signal with low brightness and negative polarity through the data line D2′ at this time. Next, the second sub-scan line S2′ transits from low voltage level to high voltage level, and the second subpixel unit A13′ receives and shows the data signal with high brightness and negative polarity through the data line D2′ at this time. Next, the first sub-scan line S3′ transits from low voltage level to high voltage level, and the first subpixel unit A23′ receives and shows the data signal with low brightness and negative polarity through the data line D2′ at this time. Afterwards, the second sub-scan line S4′ transits from low voltage level to high voltage level, and the first subpixel unit A24′ receives and shows the data signal with high brightness and negative polarity through the data line D2′ at this time.

The first scan line S5′ transits from low voltage level to high voltage level. The first subpixel A34′ receives and the data signal with low brightness and positive polarity through the data line D2′ at this time. Next, the second scan line S6′ transits from low voltage level to high voltage level, and the second subpixel unit A33′ receives and shows the data signal with high brightness and positive polarity through the data line D2′ at this time. Next, the first scan line S7′ transits from low voltage level to high voltage level, and the first subpixel unit A43′ receives and shows the data signal with low brightness and positive polarity through the data line D2′ at this time. Afterwards, the second scan line S8′ transits from low voltage level to high voltage level, and the first subpixel unit A44′ receives and shows the data signal with high brightness and positive polarity through the data line D2′ at this time.

To sum up, a single frame of an image is shown on the HSD liquid crystal display panel, whether on a displaying row or a displaying column, the subpixel unit showing the data signal with high brightness and the subpixel unit showing the data signal with low brightness are arranged alternatively. So the subpixel units have a better balanced charging effect.

In the meantime, the polarity of the data signal is reversed for the subpixel units on every two rows or on every two columns. Therefore, the subpixel units are more fully charged. The quality of the images shown on the panel is much better as well.

The connection of different scan lines for the pixel units on different rows are used in the HSD liquid crystal display panel and the liquid crystal display proposed by the preferred embodiment of the present invention. So the liquid crystal display panel can display images in multi-domains instead of arranging a multi-domain structure on the liquid crystal display panel. As can been seen, the display quality of the liquid crystal display panel is still enhanced without increasing power consumption and production costs of the liquid crystal display panel.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A half source driving (HSD) liquid crystal display panel, comprising a data line, a scan line, pixel units arranged between the data line and the scan line, wherein
each of the pixel units comprises a first subpixel unit and a second subpixel unit;
the scan line comprises a first sub-scan line for supplying a first scan signal and a second sub-scan line for supplying a second scan signal;
each of the first subpixel units on each column and the corresponding second subpixel unit are both connected to the same data line;
the first subpixel units on add rows are connected to the first sub-scan line, and the second subpixel units on add rows are connected to the second sub-scan line;
the first subpixel units on even-numbered rows are connected to the second sub-scan line, and the second subpixel units on even-numbered rows are connected to the first sub-scan line,
wherein the polarities of the data signals of the neighboring data lines are opposite,
wherein the first subpixel unit displays a data signal with high brightness, and the corresponding second subpixel unit displays a data signal with low brightness in the meantime,
wherein the first subpixel unit displays a data signal with low brightness, and the corresponding first subpixel unit displays a data signal with high brightness in the meantime.

2. The HSD liquid crystal display panel of claim 1, wherein
in one frame of an image, the polarity of the data signal through all of the data lines when the (4n+1)th first sub-scan line stays high voltage level is the same as the polarity of the data signal through all of the data lines when the (4n+2)th first sub-scan line stays high voltage level;
the polarity of the data signal through all of the data lines when the (4n+3)th first sub-scan line stays high voltage level is the same as the polarity of the data signal through all of the data lines when the (4n+4)th first sub-scan line stays high voltage level;
the polarity of the data signal through all of the data lines when the (4n+1)th first sub-scan line stays high voltage level contradicts the polarity of the data signal through all of the data lines when the (4n+3)th first sub-scan line stays high voltage level.

3. The HSD liquid crystal display panel of claim 1, wherein
in one frame of an image, the polarity of the data signal through all of the data lines when the (4n+1)th second sub-scan line stays high voltage level is the same as the polarity of the data signal through all of the data lines when the (4n+2)th second sub-scan line stays high voltage level;
the polarity of the data signal through all of the data lines when the (4n+3)th second sub-scan line stays high voltage level is the same as the polarity of the data signal through all of the data lines when the (4n+4)th second sub-scan line stays high voltage level;
the polarity of the data signal through all of the data lines when the (4n+1)th second sub-scan line stays high voltage level contradicts the polarity of the data signal through all of the data lines when the (4n+3)th second sub-scan line stays high voltage level.

4. The HSD liquid crystal display panel of claim 1, wherein
in one frame of an image, the polarity of the data signal through all of the data lines when the first sub-scan line stays high voltage level is the same as the polarity of the data signal through all of the data lines when the corresponding second sub-scan line stays high voltage level.

5. A half source driving (HSD) liquid crystal display panel, comprising a data line, a scan line, pixel units arranged between the data line and the scan line, wherein
each of the pixel units comprises a first subpixel unit and a second subpixel unit;
the scan line comprises a first sub-scan line for supplying a first scan signal and a second sub-scan line for supplying a second scan signal;
each of the first subpixel units on each column and the corresponding second subpixel unit are both connected to the same data line;
the first subpixel units on add rows are connected to the first sub-scan line, and the second subpixel units on add rows are connected to the second sub-scan line;
the first subpixel units on even-numbered rows are connected to the second sub-scan line, and the second subpixel units on even-numbered rows are connected to the first sub-scan line.

6. The HSD liquid crystal display panel of claim 5, wherein the polarities of the data signals of the neighboring data lines are opposite.

7. The HSD liquid crystal display panel of claim 6, wherein
in one frame of an image, the polarity of the data signal through all of the data lines when the (4n+1)th first sub-scan line stays high voltage level is the same as the polarity of the data signal through all of the data lines when the (4n+2)th first sub-scan line stays high voltage level;
the polarity of the data signal through all of the data lines when the (4n+3)th first sub-scan line stays high voltage level is the same as the polarity of the data signal through all of the data lines when the (4n+4)th first sub-scan line stays high voltage level;
the polarity of the data signal through all of the data lines when the (4n+1)th first sub-scan line stays high voltage level contradicts the polarity of the data signal through all of the data lines when the (4n+3)th first sub-scan line stays high voltage level.

8. The HSD liquid crystal display panel of claim 6, wherein
in one frame of an image, the polarity of the data signal through all of the data lines when the (4n+1)th second sub-scan line stays high voltage level is the same as the polarity of the data signal through all of the data lines when the (4n+2)th second sub-scan line stays high voltage level;
the polarity of the data signal through all of the data lines when the (4n+3)th second sub-scan line stays high voltage level is the same as the polarity of the data signal through all of the data lines when the (4n+4)th second sub-scan line stays high voltage level;
the polarity of the data signal through all of the data lines when the (4n+1)th second sub-scan line stays high voltage level contradicts the polarity of the data signal through all of the data lines when the (4n+3)th second sub-scan line stays high voltage level.

9. The HSD liquid crystal display panel of claim 6, wherein
in one frame of an image, the polarity of the data signal through all of the data lines when the first sub-scan line stays high voltage level is the same as the polarity of the data signal through all of the data lines when the corresponding second sub-scan line stays high voltage level.

10. The HSD liquid crystal display panel of claim 5, wherein the first subpixel unit displays a data signal with high brightness, and the corresponding second subpixel unit displays a data signal with low brightness in the meantime.

11. The HSD liquid crystal display panel of claim 5, wherein the first subpixel unit displays a data signal with low brightness, and the corresponding first subpixel unit displays a data signal with high brightness in the meantime.

12. A liquid crystal display comprising a backlight source and a half source driving (HSD) liquid crystal display panel which comprises a data line, a scan line, pixel units arranged between the data line and the scan line, wherein
each of the pixel units comprises a first subpixel unit and a second subpixel unit;
the scan line comprises a first sub-scan line for supplying a first scan signal and a second sub-scan line for supplying a second scan signal;
each of the first subpixel units on each column and the corresponding second subpixel unit are both connected to the same data line;
the first subpixel units on add rows are connected to the first sub-scan line, and the second subpixel units on add rows are connected to the second sub-scan line;
the first subpixel units on even-numbered rows are connected to the second sub-scan line, and the second subpixel units on even-numbered rows are connected to the first sub-scan line.

13. The liquid crystal display of claim 12, wherein the polarities of the data signals of the neighboring data lines are opposite.

14. The liquid crystal display of claim 13, wherein
in one frame of an image, the polarity of the data signal through all of the data lines when the (4n+1)th first sub-scan line stays high voltage level is the same as the polarity of the data signal through all of the data lines when the (4n+2)th first sub-scan line stays high voltage level;
the polarity of the data signal through all of the data lines when the (4n+3)th first sub-scan line stays high voltage level is the same as the polarity of the data signal through all of the data lines when the (4n+4)th first sub-scan line stays high voltage level;
the polarity of the data signal through all of the data lines when the (4n+1)th first sub-scan line stays high voltage level contradicts the polarity of the data signal through all of the data lines when the (4n+3)th first sub-scan line stays high voltage level.

15. The liquid crystal display of claim 13, wherein
in one frame of an image, the polarity of the data signal through all of the data lines when the (4n+1)th second sub-scan line stays high voltage level is the same as the polarity of the data signal through all of the data lines when the (4n+2)th second sub-scan line stays high voltage level;
the polarity of the data signal through all of the data lines when the (4n+3)th second sub-scan line stays high voltage level is the same as the polarity of the data signal through all of the data lines when the (4n+4)th second sub-scan line stays high voltage level;
the polarity of the data signal through all of the data lines when the (4n+1)th second sub-scan line stays high voltage level contradicts the polarity of the data signal through all of the data lines when the (4n+3)th second sub-scan line stays high voltage level.

16. The liquid crystal display of claim 13, wherein
in one frame of an image, the polarity of the data signal through all of the data lines when the first sub-scan line stays high voltage level is the same as the polarity of the data signal through all of the data lines when the corresponding second sub-scan line stays high voltage level.

17. The liquid crystal display of claim 12, wherein the first subpixel unit displays a data signal with high brightness, and the corresponding second subpixel unit displays a data signal with low brightness in the meantime.

18. The liquid crystal display of claim 12, wherein the first subpixel unit displays a data signal with low brightness, and the corresponding first subpixel unit displays a data signal with high brightness in the meantime.
